(19) United States
(12) Patent Application Publication
(10) Pub. No.: US 2007/0104345 A1
(43) Pub. Date: May 10, 2007

(54) IN-EAR TYPE EARPHONE WITH AN EAR HANGER

(76) Inventor: Bill Yang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/164,967

(22) Filed: Dec. 13, 2005

(30) Foreign Application Priority Data
Nov. 9, 2005 (TW) 94139227

(51) Int. Cl. H04R 25/00

(52) U.S. Cl. 381/381; 381/330

(57) ABSTRACT

An in-ear type earphone with an ear hanger is provided. The in-ear type earphone includes a holder, an earphone body, and the ear hanger. The holder has a guiding portion with a sliding groove, the earphone body is slidingly assembled in the sliding groove, and the ear hanger is connected to the holder.

### CROSS-REFERENCE TO RELATED APPLICATION

This application claims the priority benefit of Taiwan application serial no. 94139227, filed on Nov. 9, 2005. All disclosure of the Taiwan application is incorporated herein by reference.

### BACKGROUND OF THE INVENTION

1. Field of the Invention

The present invention relates to an earphone, and more particularly, to an in-ear type earphone with an ear hanger.

2. Description of the Related Art

Along with the continuous development of the new technology, the electronic products are designed to be lighter, thinner, shorter and smaller, thus the user can use the electronic product such as the FM radio or walkman at anytime and anywhere. In addition, the personal digital products such as the MP3 walkman, the mobile phone, the PDA (Personal Digital Assistant), and the laptop (a.k.a. the notebook) computer are well accepted and had become an inevitable device in our daily life. Moreover, a new mobile phone that supports both the FM radio and MP3 player functions is also available in the current market.

For all types of electronic products, in order to allow the user to clearly listen to the audio information provided by the electronic product without having to interfere others, the earphone had become an inevitable accessory for the electronic product. In addition, the earphone also provides a better audio transmission link to the user, such that the user can clearly hear and understand the contents of the audio, which eliminates the problem of non-clear voice transmitted in the air. When the user is in motion, such as in sports, driving, intense activity, or under a noisy environment, the user can listen to the audio clearly without being impacted by the noisy environment.

The in-ear type earphone, in which the earphone is placed into the user's ear and fixed therein, had become the most popular earphone. However, with such method of fixing the earphone on the user's ear, the signal transmission line of the earphone is easily pulled out by body movement or unintentional action, thus the earphone will easily fall out from the ear hole, which makes the ear feel uncomfortable and may also damage the earphone. Accordingly, in another conventional in-ear type earphone, an ear hanger is further disposed on the earphone to increase the fixation of the earphone.

FIG. 1 schematically shows a diagram of an in-ear type earphone disclosed in U.S. Pat. No. 5,729,615. Referring to FIG. 1, the in-ear type earphone with the ear hanger comprises: an in-ear type speaker element 28, a sliding round shaft 30, a sliding sleeve 32, an ear hanger 42, a cable 40, and a plug 43. Wherein, the sliding round shaft 30 is coupled to the in-ear type speaker element 28, and the sliding sleeve 32 is muff coupled to the sliding round shaft 30. With such mechanism, the in-ear type speaker element 28 slides up and down and freely rotates around the sliding round shaft 30, such that it can adapt with different types of ear shapes. However, the connection between the ear hanger 42 and the sliding sleeve 32 is rather weak and easily damaged, and the sliding round shaft 30 is easily broken.

### SUMMARY OF THE INVENTION

Therefore, it is an object of the present invention to provide an in-ear type earphone with an ear hanger, the earphone is suitable for adjusting to adapt with the user's different ear shapes, such that the earphone can provide optimal audio quality with a comfortable feeling.

The present invention provides an in-ear type earphone with an ear hanger. The in-ear type earphone includes a holder, an earphone body, and the ear hanger. The holder has a guiding portion with a sliding groove, the earphone body is slidingly assembled in the sliding groove, and the ear hanger is connected to the holder.

In the in-ear type earphone with the ear hanger, the holder may further comprise a pivot portion, and the ear hanger pivots on the pivot portion of the holder. In addition, the ear hanger may be suitable for sliding along the axis of the pivot.

In the in-ear type earphone with the ear hanger, the earphone body may comprise a case and a speaker element. The case is slidingly assembled in the sliding groove and the speaker element is disposed inside the case. In addition, the case may comprise at least one hole. Moreover, the in-ear type earphone may further comprise a signal transmission line, and the case has an outlet hole. Wherein, one end of the signal transmission line passing through the outlet hole is electrically coupled to the speaker element, and the other end of the signal transmission line works as an audio input port.

In the in-ear type earphone with the ear hanger, the earphone body may comprise an audio-output side and a holder side that are disposed on two sides of the guiding portion, respectively. Wherein, the holder side has a first width on a first direction and a second width on a second direction that is perpendicular to the first direction. Here, the first width is greater than the width of the guiding portion, and the second width is smaller than the width of the guiding portion. Alternatively, the end portion of the guiding portion may be a takeoff hole, and the earphone body is suitable for being taken off from the holder through the takeoff hole.

In the in-ear type earphone with the ear hanger, the ear hanger may be slidingly connected to the holder. In addition, the in-ear type earphone may further comprise an ear pad that covers an audio-output side of the earphone body. Moreover, the in-ear type earphone may further comprise a signal transmission line. Wherein, one end of the signal transmission line is electrically coupled to the earphone body, and the other end of the signal transmission line works as the audio input port. Furthermore, the guiding portion may be formed in a curve shape.

In summary, in the in-ear type earphone with the ear hanger provided by the present invention, since the link between the earphone body and the holder is designed to slide, the position of the earphone body is adjustable to adapt with the user's ear shape, such that the earphone can provide optimal audio quality with a comfortable feeling. Moreover, the in-ear type earphone with the ear hanger provided by the present invention has the advantages of better structure strength and is hard to damage.

### BRIEF DESCRIPTION DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 is a schematic diagram of a conventional in-ear type earphone with an ear hanger.

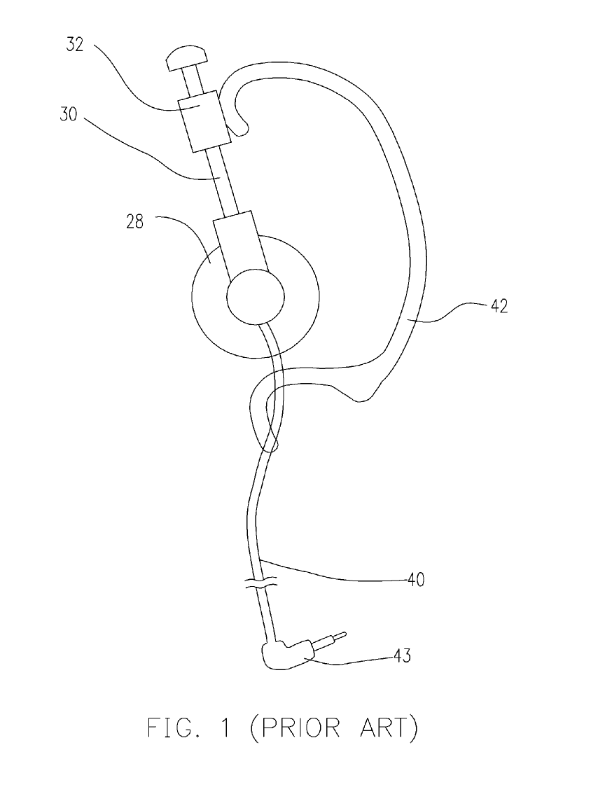

FIG. 2 is a schematic 3D diagram of an in-ear type earphone with an ear hanger according to an embodiment of the present invention.

FIG. 3 is a front view of the in-ear type earphone shown in FIG. 2.

FIG. 4 is a side view of the in-ear type earphone shown in FIG. 2.

FIG. 5 is a front view of an in-ear type earphone with an ear hanger according to another embodiment of the present invention.

FIG. 6 is a front view of an in-ear type earphone with an ear hanger according to more another embodiment of the present invention.

### DESCRIPTION PREFERRED EMBODIMENTS

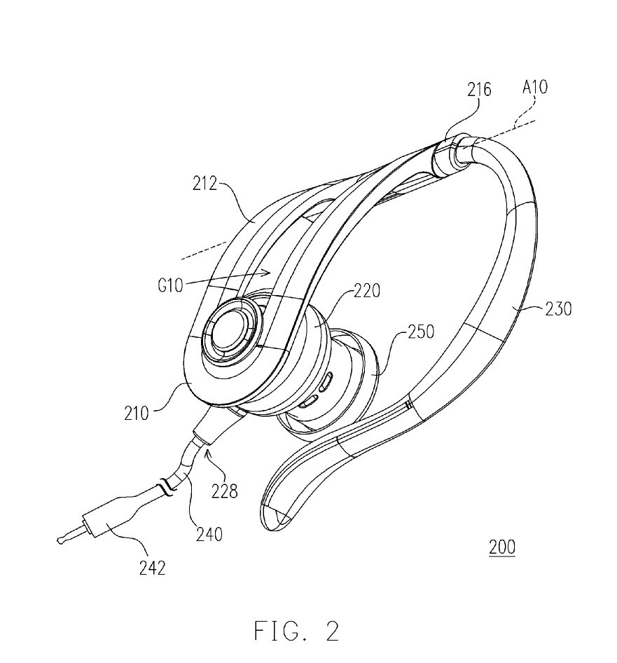

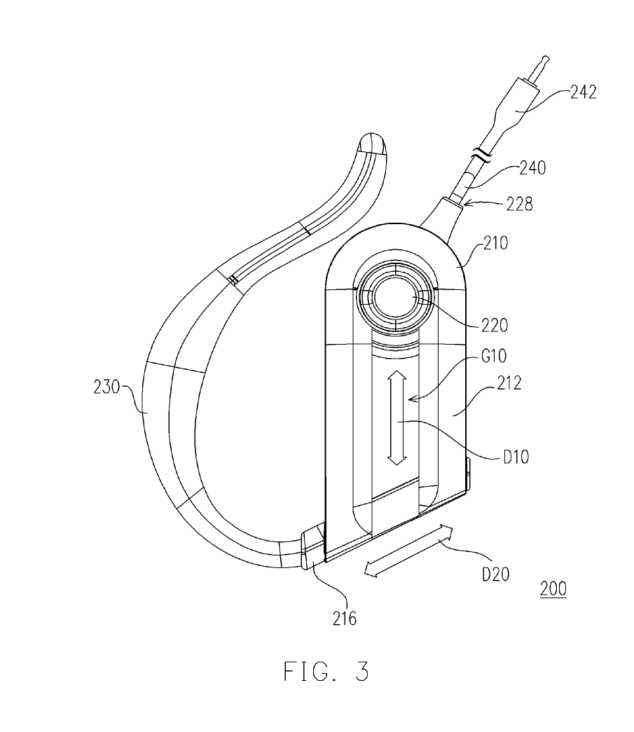

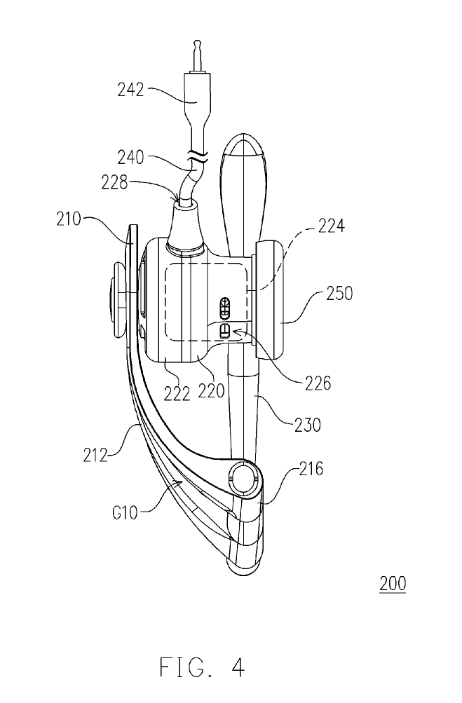

FIG. 2 is a schematic 3D diagram of an in-ear type earphone with an ear hanger according to an embodiment of the present invention. FIG. 3 is a front view of the in-ear type earphone shown in FIG. 2. FIG. 4 is a side view of the in-ear type earphone shown in FIG. 2.

Referring to FIGS. 2˜4, the in-ear type earphone with the ear hanger 200 comprises a holder 210, an earphone body 220, and an ear hanger 230. Wherein, the holder 210 has a guiding portion 212, the earphone body 220 is slidingly assembled in the guiding portion 212 of the holder 210, and the ear hanger 230 is connected to the holder 210. In the present embodiment, the guiding portion 212 with a sliding groove G10 is formed in a U-shape, and the earphone body 220 is slidingly assembled in the sliding groove G10. In addition, in order to comply with the ergonomic standard, the guiding portion 212 of the present embodiment may be designed as a curve shape. Alternatively, the guiding portion 212 also can be designed as a plat panel. Of course, it will be apparent to one of the ordinary skills in the art that different designs may be applied to the link between the earphone body 220 and the guiding portion 212, as long as the earphone body 220 can slide in the guiding portion 212.

In addition, since the earphone body 220 slides along the direction D10 in the guiding portion 212 (referring to FIG. 3), when the user hangs the in-ear type earphone 200 on his/her ear, the location of the earphone body 220 on the holder 210 can be adjusted to adapt with the user's ear shape, such that the earphone body 220 can be appropriately placed into the user's ear hole, and the user can enjoy the optimal audio quality with a comfortable feeling.

In addition, the holder 210 may comprise a pivot portion 216, and the ear hanger 230 pivots on the pivot portion 216 of the holder 210. Therefore, the ear hanger 230 pivots on the axis A10 (referring to FIG. 2) of the pivot portion 216 in the holder 210. With such design, the earphone body 220 is deeply placed into the user's ear, such that the interference of the external noise is eliminated and the audio quality is improved. When the ear hanger 230 pivots on the pivot portion 216, by modifying the mechanism design, it is possible to limit the rotating angle according to the real requirement. Moreover, an elastic portion (not shown) or another part may be further disposed between the ear hanger 230 and the pivot portion 216, so as to provide an appropriate rotating elasticity to the ear hanger 230.

Furthermore, the ear hanger 230 may be slidingly connected to holder 210. In other words, the link between the ear hanger 230 and the holder 210 may be designed in a sliding manner, such that the ear hanger 230 can slide along a direction D20 (referring to FIG. 3) on the guiding portion 212. Accordingly, the in-ear type earphone 200 is adjustable by the user to adapt with the user's ear size, so as to obtain an optimal audio quality with a comfortable feeling. When the holder 210 has the pivot portion 216, the sliding direction of the ear hanger 230 may be the same as the axis A10 of the pivot portion 216.

In the present embodiment, the earphone body 220 may comprise a case 222 and a speaker element (shown in FIG. 4 with dot line) 224. The case 222 is slidingly disposed in the guiding portion 212 of the holder 210, and the speaker element 224 is disposed inside the case 222. In addition, the case 222 may be optionally designed to be consisting of one or more audio holes 226 for adjusting the audio field of the speaker element 224, so as to provide better audio quality. Moreover, if the in-ear type earphone 200 is designed to be wired, the in-ear type earphone 200 may further comprise a signal transmission line 240, and the case 222 has an outlet hole 228. Here, one end of the signal transmission line 240 passing through the outlet hole 228 is electrically coupled to the speaker element 224, and the other end of the signal transmission line 240 works as the audio input port 242. The audio input port 242 is provided to connect with various audio source devices such as the mobile phone, the stereo device, and the MP3 player for receiving the audio signals. Of course, the in-ear type earphone 200 may be designed to be wireless. In such case, the audio signal is received in a wireless manner.

Moreover, the in-ear type earphone 200 may further comprise an ear pad 250. The ear pad 250 covers the audio-output side of the earphone body 220, such that the user can feel more comfortable when hanging the earphone. The ear pad 250 may be made of various soft materials such as the rubber, silica gel, and sponge.

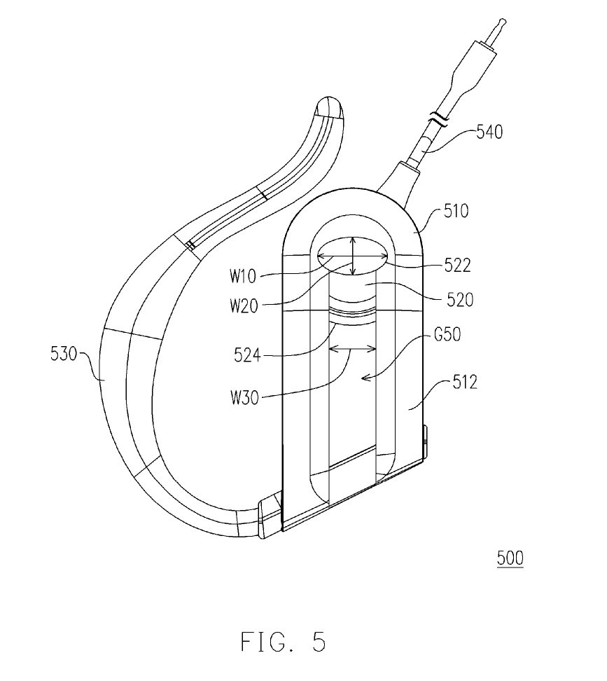

In addition, the link between the earphone body 220 and the holder 210 may be designed as removable. FIG. 5 is a front view of an in-ear type earphone with an ear hanger according to another embodiment of the present invention. Referring to FIG. 5, in the present embodiment, the earphone body 520 has an audio-output side 524 and a holder side 522 that are disposed on two sides of the guiding portion 512, respectively. Wherein, the holder side 522 has a first width W10 on the X-direction and a second width W20 on the Y-direction that is perpendicular to the X-direction. The first width W10 is greater than a width W30 of the sliding groove G50, and the second width W20 is smaller than the width W30 of the sliding groove G50. Therefore, when the earphone body 520 is sliding in the sliding groove G50 with the certain tilt angle shown in FIG. 5, the earphone body 520 is placed and clamped in the sliding groove G50. In addition, when the earphone body 520 rotates 90 degrees, since meanwhile the second width W20 of the earphone body 520 is smaller than the width W30 of the sliding groove G50, the earphone body 520 can be taken off from the holder 510 and the earphone body 520 can be used independently.

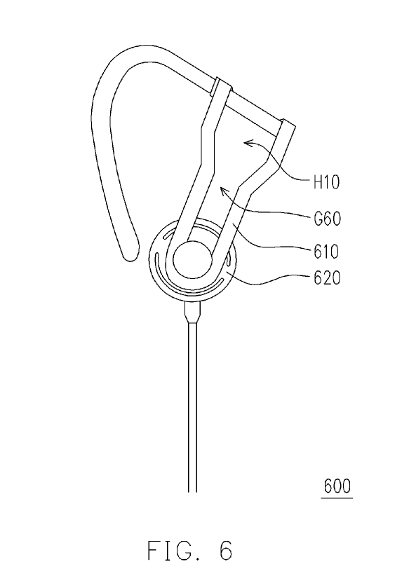

FIG. 6 is a front view of an in-ear type earphone with an ear hanger according to more another embodiment of the present invention. Referring to FIG. 6, in the present embodiment, the in-ear type earphone 600 is similar to the in-ear type earphone 200 shown in FIG. 2. The difference between the in-ear type earphones 200 and 600 is that a takeoff hole H10 is designed on the end portion of the sliding groove G60, and the size of the takeoff hole H10 is greater than the size of the end portion of the earphone body 620, such that the earphone body 620 can be taken off from the holder 610 through the takeoff hole H10. Moreover, the takeoff hole H10 can be specially designed, such that the earphone body 620 has to be tilted in a certain angle in order to be taken off from the holder 610. With such design, the earphone body 620 is not easily detached from the holder 610. After referring to the accompanying drawings, the one of the ordinary skills in the art should easily understand the design of the takeoff hole H10, thus its detail is omitted herein. In addition, with such design, the user can easily take off the earphone body 620 from the holder 610 and use the earphone body 620 alone, which further improves the agility of the in-ear type earphone 600. Of course, the embodiments mentioned above are exemplified herein for describing the present invention, the earphone body 620 may be taken off from the holder 610 with different designs according to the real requirements.

It is to be noted that even the drawing of each embodiment mentioned above is the single-side earphone, the double-side earphone is also applicable to the present invention.

In summary, in the in-ear type earphone with the ear hanger provided by the present invention, the link between the earphone body and the holder is designed in a sliding manner, thus the user can adjust the location of the earphone body according to his/her ear shape to obtain the optimal audio quality with a comfortable feeling. In addition, a pivot-type design and/or a sliding-type design also can be applied to the link between the ear hanger and the holder. Moreover, a removable-type design may be applied on the link between the earphone body and the holder. With such designs, the in-ear type earphone with the ear hanger provided by the present invention is more suitable to adapt with the user's ear shape for providing an optimal audio quality with a comfortable feeling, and providing more adjustable spaces in different directions so as to improve the user's convenience. Furthermore, the in-ear type earphone with the ear hanger provided by the present invention has the advantages of better structure strength and is hard to damage.

Although the invention has been described with reference to a particular embodiment thereof, it will be apparent to one of the ordinary skills in the art that modifications to the described embodiment may be made without departing from the spirit of the invention. Accordingly, the scope of the invention will be defined by the attached claims not by the above detailed description.

What is claimed is:

1. An in-ear type earphone with an ear hanger, comprising:
a holder having a guiding portion, wherein the guiding portion comprises a sliding groove;
an earphone body slidingly assembled in the sliding groove; and
an ear hanger connected to the holder.

2. The in-ear type earphone with the ear hanger of claim 1, wherein the holder further comprises a pivot portion, and the ear hanger pivots on the pivot portion of the holder.

3. The in-ear type earphone with the ear hanger of claim 2, wherein the ear hanger is suitable for sliding along an axis of the pivot portion.

4. The in-ear type earphone with the ear hanger of claim 1, wherein the ear hanger is slidingly connected to the holder.

5. The in-ear type earphone with the ear hanger of claim 1, further comprising an ear pad that covers an audio-output side of the earphone body.

6. The in-ear type earphone with the ear hanger of claim 1, wherein the earphone body comprises:
a case slidingly assembled in the sliding groove; and
a speaker element disposed inside the case.

7. The in-ear type earphone with the ear hanger of claim 6, wherein the case comprises at least an audio hole.

8. The in-ear type earphone with the ear hanger of claim 6, further comprising a signal transmission line, wherein the case has an outlet hole, one end of the signal transmission line passing through the outlet hole is electrically coupled to the speaker element, and the other end of the signal transmission line works as an audio input port.

9. The in-ear type earphone with the ear hanger of claim 1, further comprising a signal transmission line, wherein one end of the signal transmission line is electrically coupled to the earphone body, and the other end of the signal transmission line works as an audio input port.

10. The in-ear type earphone with the ear hanger of claim 1, wherein the earphone body comprises an audio-output side and a holder side that are disposed on two sides of the guiding portion respectively, the holder side has a first width on a first direction and a second width on a second direction that is perpendicular to the first direction, and the first width is greater than a width of the sliding groove, and the second width is smaller than the width of the sliding groove.

11. The in-ear type earphone with the ear hanger of claim 1, wherein the end portion of the sliding groove is a takeoff hole, and the earphone body is suitable for being taken off from the holder through the takeoff hole.

12. The in-ear type earphone with the ear hanger of claim 1, wherein the guiding portion is formed in a curve shape.
